(19) United States
(12) Patent Application Publication
(10) Pub. No.: US 2024/0295696 A1
(43) Pub. Date: Sep. 5, 2024

(54) MODE FIELD ADAPTER

(71) Applicant: TRUMPF Laser GmbH, Schramberg (DE)

(72) Inventors: Soeren Kumkar, Schramberg (DE); Aleksander Budnicki, Waldkirch (DE); Florian Jansen, Villingen-Schwenningen (DE)

(21) Appl. No.: 18/661,760

(22) Filed: May 13, 2024

Related U.S. Application Data
(63) Continuation of application No. PCT/EP2022/081694, filed on Nov. 14, 2022.

(30) Foreign Application Priority Data
Nov. 15, 2021 (DE) 10 2021 129 669.2

(51) Int. Cl. G02B 6/14; H01S 3/067; H01S 3/094

(52) U.S. Cl. CPC G02B 6/14; H01S 3/06754; H01S 3/094

(57) ABSTRACT

A mode field adapter for adapting a mode field of an input fibre to a mode field of an output fibre includes a mode field adapter fibre. The mode field adapter fibre includes a mode field adaptation section for adapting a mode field diameter of the mode field of the input fibre to the mode field of the output fibre. The mode field adapter fibre has a length between 5 mm and 150 mm. The mode field adaptation section has a length between 5 mm and 150 mm. The mode field adapter fibre is configured to transfer light from the input fibre in a polarization maintaining manner into the output fibre.

### CROSS REFERENCE TO RELATED APPLICATIONS

This application is a continuation of International Application No. PCT/EP2022/081694 (WO 2023/084066 A1), filed on Nov. 14, 2022, and claims benefit to German Patent Application No. DE 10 2021 129 669.2, filed on Nov. 15, 2021. The aforementioned applications are hereby incorporated by reference herein.

### FIELD

Embodiments of the present invention relate to a mode field adapter for adapting a mode field of an input fibre to the mode field of an output fibre, in particular for use in high-performance fibre laser systems.

### BACKGROUND

Laser-active light guide fibres having a small mode field are advantageous for the implementation of fibre lasers having high beam quality (i.e., for example, having a diffraction index close to 1), while high output powers require optical amplifiers having a large mode field. In order to be able to connect an input fibre having a small mode field to an output fibre having a large mode field, a mode field adapter is used. In a typical practical application of a mode field adapter, for example for fibre laser systems, first a comparatively weak laser power is fed into the small mode field of the active (doped) core of the input fibre (for example by an external laser source) and possibly pre-amplified by a further external optical pump signal guided in the fibre. This ensures laser light having a high beam quality and a correspondingly preferably dominant fundamental mode, which is transferred via the mode field adapter into a range of a large mode field. Providing a larger mode field in the output fibre enables, due to the greater maximum tolerable power of the laser light linked thereto, an increased maximum output power of the laser by way of external optical amplifiers.

A mode field adapter is known from US 2011/0249321 A1, which connects a seed fibre or input fibre to an amplifier fibre or output fibre, wherein the output fibre has a larger core diameter than the input fibre. The mode field adapter has a first fibre having an inner area having homogeneous refraction index distribution, wherein the inner area of homogeneous refraction index distribution is larger than the core diameter of the seed laser or input fibre. Furthermore, the mode field adapter has a second fibre downstream from the first fibre having an inner area having a radially gradually decreasing refraction index (graded index (GRIN)). The length of the GRIN fibre/GRIN lens is adapted so that the laser light from the input fibre is focused in the core area of the output fibre. The smaller core of the input fibre corresponds here to a small mode field diameter, wherein the larger second core of the output fibre corresponds to a large mode field diameter. The fibre having homogeneous refraction index in the inner area, which represents the first part of the mode field adapter, thus expands the mode field of the light originating from the narrow input fibre core, which is collimated in the downstream second part, the gradient index fibre, in the larger fibre core of the output fibre, by which the mode field is adapted.

The two-part structure of the mode field adapter of this type requires a relatively high and complex production effort, since splicing has to be performed at three positions and cleaving has to be performed a total of four times for the connection of the input fibre, the mode field adapter and the output fibre. Multiple splicing processes also call for elevated power losses at the spliced points, in addition to the increased production effort.

Furthermore, the very short mode field adapter components have to be manufactured very precisely in order to ensure a suitable collimation of the laser light in the downstream output fibre having larger mode volume. This is in particular of great relevance to obtain a high beam quality.

To ensure a polarization maintaining guidance of the laser light through the mode field adapter, in this design a very short embodiment of the mode field adapter (between 0.5 mm and 1 mm) is additionally necessary, which limits the embodiment of the component.

### SUMMARY

Embodiments of the present invention provide a mode field adapter for adapting a mode field of an input fibre to a mode field of an output fibre. The mode field adapter includes a mode field adapter fibre. The mode field adapter fibre includes a mode field adaptation section for adapting a mode field diameter of the mode field of the input fibre to the mode field of the output fibre. The mode field adapter fibre has a length between 5 mm and 150 mm. The mode field adaptation section has a length between 5 mm and 150 mm. The mode field adapter fibre is configured to transfer light from the input fibre in a polarization maintaining manner into the output fibre.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of the longitudinal section of a mode field adapter fibre and a cross section of an input fibre and an output fibre, according to some embodiments;

FIG. 2 shows a schematic representation of a longitudinal section of the mode field adapter fibre in connection with the input and output fibres having polarization maintaining structures, according to some embodiments;

FIG. 3 shows a schematic representation of the mount for fixing the input and output fibres and the mode field adapter, according to some embodiments; and

FIG. 4 shows a schematic representation of the structure of the fibre laser system including the mode field adapter, according to some embodiments.

### DETAILED DESCRIPTION

Embodiments of the present invention provide an improved mode field adapter for adapting a mode field of an input fibre to the mode field of an output fibre, in particular with respect to facilitated production with polarization maintaining light guidance in the transition area at the same time.

Accordingly, a mode field adapter for adapting a mode field of an input fibre to the mode field of an output fibre is proposed, comprising a mode field adapter fibre. According to embodiments of the invention, the mode field adapter fibre has a mode field adaptation section for adapting the mode field diameter of the mode field of the input fibre to the mode field of the output fibre, wherein the mode field adapter fibre has a length between 5 mm and 150 mm and the mode field adaptation section has a length between 5 mm and 50 mm, preferably a length between 15 mm and 50 mm, wherein the mode field adapter fibre transfers polarized light from the input fibre in a polarization maintaining manner into the output fibre.

The embodiments of the input and output fibres can be of different fibre types. Embodiments of the present invention can include, but is not limited to: Step index fibres, gradient index fibres, and micro-structured fibres in the form of hollow core fibres or photonic crystal fibres (PCF). In particular photonic bandgap fibres and double-clad PCFs having active core are to be mentioned with respect to PCFs, wherein the latter are relevant for fibre laser applications.

In particular, it is possible to connect an input fibre of a specific type to an output fibre of another type via the mode field adapter described here.

The different fibre types which can be used in exemplary embodiments of the input and output fibres will be briefly described hereinafter. However, embodiments of the invention are not restricted to the explicitly presented fibre types.

Step index fibres comprise a fibre cladding and a light-guiding core and are characterized in particular by a refraction index changing in steps, wherein the refraction index of the core is greater than the refraction index of the fibre cladding, by which its light-guiding property is ensured.

Alternatively, double-clad step index fibres can be used, comprising two coaxially arranged fibre claddings, wherein the refraction index of the outer cladding is less than the refraction index of the inner cladding, and the refraction index of the inner cladding is less than that of the fibre core. Accordingly, a light-guiding property of the fibre core and a further light-guiding property of the inner cladding is ensured.

Single- and also double-clad step index fibres can also be equipped with an active doped core, wherein the doping can be carried out, for example, using rare earth metals. Active cores having doping are important in particular for fibre laser systems. In the double-clad fibre design, the light-guiding property of the inner cladding is preferably used for optical amplification of laser light guided in an active doped core.

In gradient index fibres, a well-defined light-guiding core is not defined, rather the light guiding is achieved via a refraction index decreasing gradually and radially outward. These fibre types in particular enable a reduced modal dispersion of the guided light.

In photonic crystal fibres, a fibre is micro-structured, wherein the micro-structuring corresponds to a periodic arrangement of holes along the fibre axis. For example, the solid core of the fibre can be unstructured, while the surrounding fibre material is structured using holes in the form of a triangular lattice or honeycomb lattice. The light-guiding property is achieved by an effectively higher refraction index in the unstructured core in relation to the structured cladding.

Alternatively, a photonic crystal fibre can be embodied as a photonic bandgap fibre. An air-filled hollow core can be formed here, for example, which is enclosed by a periodically structured cladding, which is structured, for example, as a triangular lattice or honeycomb lattice having air-filled holes. The periodic structure of the refraction index in the cladding of this type influences the propagation of the light by diffraction and interference and can enable an exclusive propagation of light within a narrow wavelength range in the hollow core, wherein the propagation of light outside this range is suppressed. Fibre designs having a hollow air-filled core are also referred to as hollow-core fibres. In contrast to the above-described fibre types, photonic bandgap fibres do not guide the light by means of refraction index differences between core and cladding, but rather via the periodic arrangement of the hole structure in the cladding, which results in a photonic bandgap and permits or suppresses the propagation of specific wavelengths.

Photonic crystal fibres, in a further alternative, instead of having an undoped solid fibre core or an air-filled hollow core, can also be embodied having an active doped core, wherein the active core can be doped using various rare earth metals. This variant is of special relevance in particular for fibre laser systems.

Furthermore, photonic crystal fibres or photonic bandgap fibres can also be embodied as double-clad fibres. In particular, the second cladding can be embodied as an air cladding (“air clad”), which is implemented, for example, by means of concentrically arranged air-filled holes around the fibre core. The air cladding causes a light-guiding property in the inner cladding, which is important in particular for optical amplification in fibre laser systems.

The exemplary air cladding just described is not limited to photonic crystal fibres, but rather can be used in any fibre types.

Proceeding from fibre-guided light of a specific wavelength, with the exception of step index fibres, there is no simple relationship between the geometric core diameter or the cross-sectional area of the core of a fibre and its associated mode field. This is apparent in particular for those fibre types which do not have a well-defined core diameter (such as gradient index fibres). Since the mode field adaptation of the mode field adapter according to embodiments of the invention is not restricted to step index fibres, predominantly the mode field is used in the scope of the invention to characterize the fibres.

The mode field of an arbitrary glass fibre type can in general be expressed by an effective mode field area A_{eff}, which corresponds to a measure of the effectively covered cross-sectional area of the spatial intensity distribution of the light modes present in the fibre. A generally valid expression, independent of the fibre type, for the effective mode area A_{eff} of a fibre having longitudinal direction along the z axis and axes x and y transverse thereto can be calculated as follows:

$${A}_{eff} = \frac{{( \int I ( x , y ) dxdy )}^{2}}{\int {( I ( x , y ) )}^{2} d x d y} ,$$

wherein I(x, y) is the spatial intensity distribution of the light modes and the integration extends over the cross-sectional area of the complete fibre, also outside the light-guiding core. The intensity distribution of the light modes can be determined either by measurement or by numeric simulation of the mode profile. The terms mode field and effective mode field area are to be used synonymously hereinafter.

Furthermore, fibres are distinguished into single mode fibres and multimode fibres. While single mode fibres are conceived so that they can guide only the fundamental mode having an approximately Gaussian radial intensity profile for a defined light wavelength, in multimode fibres the propagation of multiple modes is permitted. With the exception of photonic crystal fibres, the number of the permitted modes is essentially determined by the effective mode field area A_{eff} of the guided light of a specific wavelength and the numeric aperture of the fibre. The special design of photonic crystal fibres enables, however, with nominally equal effective mode field area and numeric aperture, a significantly reduced number of permitted modes in relation to more conventional fibre types such as step index fibres or gradient index fibres.

To implement a high beam quality having refraction index close to 1, single mode fibres are preferred, since the light propagation of these modes at the fibre output is only limited by refraction. Furthermore, the use of single mode fibres having a great effective mode field area, for example by means of photonic crystal fibres, is advantageous, since they enable a simultaneous implementation of high output beam quality and large mode field. Since a large mode field permits high optical powers, for example, high-power laser light can be achieved in fibre laser systems with high brilliance at the same time.

In the case of a single mode fibre having Gaussian radial intensity profile, the effective mode field area can be characterized via the mode field radius w, wherein the following applies A_{eff}=πw². In this case, the mode field can also be expressed via the mode field diameter d=2w.

In the special case of step index fibres, the mode field radius w can also be determined with the aid of the geometric core radius a of the relevant fibre. According to Marcuse's equation, the following applies:

$$\frac{w}{a} \approx 0.65 + \frac{1.619}{{V}^{\frac{3}{2}}} + \frac{2.879}{{V}^{6}} .$$

Here, V designates the so-called V number, given by

$$V = \frac{2 π}{λ} a NA = \frac{2 π}{λ} a \sqrt{{n}_{core}^{2} - {n}_{cladding}^{2}} ,$$

wherein λ is the wavelength of the laser light used and NA=\sqrt{n_{core}²−n_{cladding}²} is the numeric aperture of the fibre. The latter is determined by the refraction index n_{core} of the core and the refraction index n_{cladding} of the adjoining fibre cladding of the step index fibre. The V number corresponds to a dimensionless parameter, which can be viewed as a type of normalized optical frequency. In other words, for the calculation of the V number, the geometric fibre core radius a weighted using the numeric aperture NA is normalized to the laser frequency used, which is proportional to the reciprocal wavelength 1/λ. The V number is in particular a delimitation criterion between single mode fibres and multimode fibres with respect to step index fibres. In particular for V≤2.405, a fibre can only transport one mode (the fundamental mode) per polarization direction. Multimode fibres are accordingly characterized by greater V numbers.

The main difference between the input and output fibre is characterized in particular in that the mode field of the input fibre differs from the mode field of the output fibre.

In one embodiment, for example, the mode field of the input fibre can be smaller than the mode field of the output fibre.

In a further embodiment, the mode field of the input fibre can also be larger than the mode field of the output fibre.

The function of the mode field adapter is not restricted to the adaptation of mode fields for single mode fibres or multimode fibres, an adaptation can take place correspondingly for both fibre types. In particular, the input fibre can be a single mode fibre and the output fibre a multimode fibre or vice versa.

In the special case of step index fibres, the classification of a fibre as a single mode fibre or multimode fibre can take place with the aid of the V number. For a defined wavelength and a likewise defined numeric aperture of the light-guiding core, the fibre is classified as a single mode fibre if V≤2.405, and as a multimode fibre if V≥2.405.

For complicated/other fibre types, there is no generally valid criterion for the classification of the fibres as single mode fibres or multimode fibres. Numeric simulations of the mode profile of the relevant fibres are then typically necessary.

The proposed mode field adapter which is intended for the connection between the above-described input and output fibres is in particular itself embodied as a glass fibre and comprises a core and a cladding, wherein the cladding has a lower refraction index than the light-guiding core. The mode field adapter fibre of this type has a length between 5 mm and 150 mm, and a mode field adaptation section, which in particular has a length between 5 mm and 150 mm, preferably a length between 15 mm and 50 mm.

In particular, the core diameter is embodied as expanding within a mode field adaptation section along its longitudinal direction and accordingly comprises one end having non-expanded core and one end having maximally expanded core. In general, the cladding diameter can correspond to the gradual expansion of the core, in one preferred embodiment the cladding diameter is constant, however, and is at least 130 μm and less than 900 μm, in one preferred embodiment, for example, 400 μm.

The expanding core diameter of the mode field adapter corresponds to an increasing mode field, however, a generally valid relationship between the geometric core diameter and the mode field is not provided due to different production processes of the mode field adapter. However, according to the previously introduced definition, the mode field can be characterized by the effective mode field area A_{eff}. An adaptation of the mode fields at the input and output sides of the mode field adapter therefore generally takes place via an adaptation of the mode fields and not necessarily via an adaptation of the geometric core diameter. The latter is only reasonable for step index fibres, in which a clear separation between core and cladding can be indicated via the refraction index changing in steps.

Accordingly, the end of the mode field adapter which has the non-expanded core diameter has a comparatively small mode field and is adapted to the mode field of the input fibre, while the end having the maximally expanded core diameter has a larger mode field and is adapted to the mode field of the output fibre.

According to an above-described alternative, the mode field of the input fibre can also be larger than the mode field of the output fibre. The mode field adapter can be used in reverse here and thus convert a large mode field of the input fibre into a smaller mode field of the output fibre.

The core of the mode field adapter gradually expanding in diameter can be implemented by various processes. One typical method for producing the mode field adapter fibre is the “tapering” of a fibre, wherein a fibre is locally heated and pulled apart at its ends at the same time, due to which it becomes thinner and longer at the heated point. Corresponding cleaving at the thinned point and at an unchanged thicker point creates the mode field adapter. In this method, the expansion of the light-guiding core and the cladding corresponds.

A further preferred possibility for producing the mode field adapter is the thermal expansion of the core (TEC, “thermally expanded core”) of the mode field adapter fibre. A fibre having a small mode field is subjected here to a heating profile varying along the longitudinal axis. A diffusion of the glass components defining the radial profile of the fibre core thus takes place and the mode field of the base mode enlarges. It is to be noted that in the TEC method, the boundary of the core to the cladding is no longer well-defined due to the process. Accordingly, a well-defined value of the geometric core diameter cannot be given in the expanded area of the core. In this case, the mode field is again calculated/measured to define the light-guiding part of the fibre.

Accordingly, in one exemplary embodiment the core of a thermally expanded mode field adapter fibre has, for example, a gradual expansion of the geometric core diameter from 10 μm to a mode field diameter of 30 μm. It is to be noted here that according to the introduced definition of the mode field via the effective mode field area, the specification of a mode field diameter is only reasonable for radially symmetrical mode profiles of the light in the fibre, since a circular definition of the mode field area is only permissible in this case. The latter is typically reliably provided only in single mode fibres. For adequate adaptation of the mode field to a following single mode output fibre, this is accordingly to be likewise embodied having a mode field diameter of 30 μm.

For the connection of the mode field adapter fibre to the input and output fibres, initially polishing and possibly cleaving are each performed on the non-expanded end and on the maximally expanded end of the mode field adapter fibre. The goal of the polishing and/or cleaving is to create the most perfectly flat end possible of the fibre. After the polishing and/or cleaving, the two ends of the mode field adapter fibre are spliced on the input fibre or output fibre, respectively, wherein the corresponding mode fields of the fibre cores are connected to one another. During the splicing of the fibres, the light-guiding cores of the glass fibres to be spliced are adjusted to one another with pinpoint accuracy, and then connected to one another via various methods. For example, the connection can take place via a fusion splice, in which the ends are fused with one another using an electric arc.

Such a monolithic structure (i.e., the mode field adaptation of the input and output fibres takes place by means of a mode field adapter, which is exclusively manufactured using fibre components) enables a compact, robust, and cost-efficient embodiment of the device.

Maximum tolerable power losses at the connection points, thus the transition between input fibre and mode field adapter fibre, and between mode field adapter fibre and output fibre, can be defined for the case of single mode fibres as the quantitative criterion for a proper function of the mode field adapter. Accordingly, the input fibre, which can guide a fundamental mode using a small mode field, is to be adapted to the input-side mode field of the mode field adapter fibre so that (for example, by means of an input-side splice of the input fibre on the mode field adapter fibre) an optical coupling of the mode fields is possible with a loss of <3 dB, preferably <1 dB. On the output side, the mode field adapter fibre having enlarged mode field is to be adapted to the likewise larger mode field of the output fibre so that a loss of <3 dB, preferably <2 dB, is possible.

In one preferred embodiment, the input and output fibres are made polarization maintaining (PM). Polarization maintaining means that light of a specific polarization state radiated into a fibre maintains this polarization state over a specific distance along the fibre. A worsening of the polarization state opposite thereto is induced in that increasingly orthogonal polarization states of the light are present (in comparison to the polarization state of the irradiated light). A quantitative dimension to describe the polarization state can be indicated via the polarization ratio, which can be formed from the desired polarization component of the irradiated light and the proportion of the polarization state orthogonal thereto. A change of the polarization state can accordingly be indicated by the percentage proportion of the irradiated polarization of light which is converted into the polarization orthogonal thereto during the passage through the mode field adapter fibre.

Without special manufacturing, a fibre is already not polarization maintaining over very short distances, since in spite of the circular symmetry of a fibre, ultrasmall contaminations, asymmetries, or stress-generating bends induce a weak and random parasitic birefringent property of the fibre, which, due to the typically very small microscopic light wavelengths, however, already has a significant influence on the polarization due to the birefringence-induced coupling between the polarization states over short but macroscopic distances. To manufacture polarization maintaining fibres, for example, a strong but well-defined birefringence is therefore intentionally created in the fibre, due to which two well-defined polarization states having unique and different phase velocities can propagate.

For a specified wavelength, the beat length can then be defined, which is given by the distance along the fibre over which one of the polarization states experiences a delay of one wavelength in relation to the polarization state orthogonal thereto. If one observes a polarization state 1 (with polarization state 2 orthogonal thereto) at a point 0 along the fibre, the intrinsic parasitic coupling between the orthogonal polarization states ensures a finite amplitude in polarization state 2 having defined phase. After the propagation of the light wave over half a beat length, this random coupling in turn ensures a finite amplitude in polarization state 2, but with a 180° phase shift in comparison to the coupling at the point 0, due to which cancellation of the wave components in polarization state 2 takes place. In other words, for a polarization maintaining fibre, the beat length from the externally induced birefringence is to be significantly less than the length scale on which the parasitic birefringent coupling varies due to intrinsic effects such as bending and contaminants. Accordingly, the irradiated polarization is maintained over a distance which corresponds to a multiple of the beat length.

A fibre manufactured according to this principle can be created, for example, by noncircular symmetries of the fibre cladding and/or the core, or by opposing axially extending rods within the fibre cladding, which are configured such that they can induce a stress-induced birefringence.

The proposed mode field adapter is polarization maintaining in spite of the very long embodiment of the mode field adapter fibre, although the fibre material of the mode field adapter does not have polarization maintaining structures. This feature is enabled in that (1) the non-PM fibre piece, which represents the mode field adapter, is nonetheless sufficiently short, (2) the PM input fibre and the PM output fibre are aligned to one another before the splicing in accordance with their polarization axis, and (3) the entire area of the transition in the mode field adapter fibre is mounted with sufficiently low stress to avoid worsening of the degree of polarization due to stress-induced birefringence. Under these conditions, a test signal can then be coupled into the input fibre and the power and the polarization ratio at the output fibre can be optimized or maximized by alignment of the fibres to one another.

The above-mentioned methods for producing the mode field adaptation section are significantly easier to implement using non-polarization maintaining fibres, in particular with large differences between the diameters of the input and output fibres. The presently proposed mode field adapter fibre, which describes polarization maintaining light guiding without explicitly polarization maintaining structures, therefore ensures greatly simplified production of a polarization maintaining mode field adapter.

In particular, the mode field adapter fibre does not have any explicitly formed polarization maintaining structures, such as tension rods or other birefringent structures, for example, which are to result in a polarization maintaining propagation of the waves. Asymmetrical fibre or cladding constructions, which can result in maintaining polarization, are also not provided for the mode field adapter fibre.

The mode field adapter fibre is mounted by a mount in an unbent manner, preferably straight, preferably with a radius of curvature of greater than 10 m. It is thus ensured that randomly distributed or inhomogeneous stress-induced birefringence is avoided or reduced and the polarization in the mode field adapter is substantially maintained over its length.

Said mount comprises a tube, preferably a glass tube, which fixes the input fibre and the output fibre by means of a respective adhesive spot in the tube. The mode field adapter fibre is accordingly mounted indirectly in the tube, wherein the two adhesive spots close the tube.

Embodiments of the present invention are not restricted to a tubular mount of the mode field adapter, rather any other suitable geometry for the mount is also usable in the scope of the invention.

In one refinement, the indirect fastening of the mode field adapter fibre is fastened in a quartz glass tube. The fastening takes place via two adhesive spots, wherein the adhesive spots are designed such that they seal the tube closed. The sealing adhesive spots primarily prevent/reduce the penetration of particles, but presumably also the penetration of water vapour. The most tension-free mounting is preferred here to avoid the stress-induced birefringence. A preferably soft adhesive is accordingly to be used for the fastening.

In one preferred embodiment, the change of the polarization state, thus the percentage proportion of the irradiated polarization of light which is converted during the passage through the mode field adapter fibre into the polarization orthogonal thereto by means of the above-mentioned tension-free mount, is less than 25% (−6 dB), preferably less than 1% (−20 dB).

In one preferred application, the fibre connection between the input fibre, the mode field adapter fibre, and the output fibre can be used as a laser amplification system. For this purpose, the input and/or output fibre can be embodied having a doped fibre core, which functions as the active laser medium. The doping can be carried out using suitable atoms such as erbium, ytterbium, thulium, or neodymium, wherein embodiments of the present invention are not limited to the mentioned doping atoms. The doping of the core forms, for the fibres of the fibre laser, the active medium for the stimulated emission and amplification of irradiated laser light.

In fibre laser amplifier systems, which have high requirements for large output powers with high beam quality at the same time, the use of mode field adapters having a large mode field on the output side is relevant. This is because fibres having a small mode field but high light powers have very large optical intensities, which result in undesired nonlinear light-material interactions. The latter result in, among other things, frequency conversions and therefore influence the quality of the laser light. Such nonlinear effects can be suppressed by the provision of large mode fields, since the optical intensity can be kept comparatively low therein.

In one embodiment, the input fibre can be designed as a preamplifier fibre and/or the output fibre as a main amplifier fibre. This means in particular that the fibres are embodied having an active medium in the core, by which the laser light power can be amplified by means of external pump light. The embodiment of the input fibre as a preamplifier fibre means in particular that the power of the laser light is limited by the smaller mode field. In contrast, the comparatively large mode field of the output fibre embodied as the main amplifier fibre provides a large possible output power.

In the case of a single-clad input and/or output fibre according to the above-mentioned embodiments, pump light for amplifying the laser light can be coupled into the core of the input fibre and/or output fibre.

In the case of a double-clad input and/or output fibre according to the above-mentioned embodiments, the pump light for amplifying the laser light can be coupled into the inner cladding of the input fibre and/or output fibre.

The embodiment just mentioned based on double-clad amplifier fibres is preferred for the laser amplification, since the coupling of pump light into the inner cladding enables a higher pump power in comparison to the coupling into the core of a single-clad amplifier fibre and ensures a high beam quality of the laser light guided in the comparatively narrow core at the same time.

In a typical embodiment by means of step index fibres, the input fibre is manufactured as a preamplifier fibre having small core diameters, preferably in the order of magnitude ≤10 μm. In contrast, a high power can be enabled at the end of the amplifier chain in that the output fibre is used as the main amplifier fibre having larger core diameters, preferably in the order of magnitude ≥20 μm.

For the complete implementation of the laser system, laser radiation, such as laser pulses, is first generated in a seed source. This laser light is coupled into the core of the input fibre having small mode field and possibly pre-amplified. The mode field adapter is located downstream, in which the coupled-in laser light having small mode field from the input fibre is adapted to the enlarged mode field of the output fibre. The output fibre is used as an amplifier fibre in that laser radiation from a pump source is coupled into the cladding of the output fibre via a pump signal combiner. The coupled-in pump light amplifies the laser radiation in the output fibre. Amplified laser radiation exits from the output fibre of the laser system.

The seed source is designed, for example, as a diode having fibre amplifier, fibre oscillator, and possibly having preamplifier. Alternative ways of providing laser light for coupling into the input fibre are not excluded here.

The pump source can be embodied, for example, as one or more fibre-coupled laser diodes, which are typically coupled to multimode fibre(s), wherein the latter are designated as pump fibres.

The pump signal combiner provides a device for coupling the pump light originating from an external pump source into the lateral surface of the output fibre embodied as the main amplifier fibre, wherein the pump light is guided in the associated pump fibres. For example, multiple pump fibres from the pump source can be connected to the main amplifier fibre for this purpose. The latter typically takes place in such a way, but is not limited thereto, that the pump fibres are arranged around the output fibre and the entire bundle (typically surrounded by a glass tube) is tapered so that its dimensions correspond to those of the active fibre. Accordingly, the pump fibres and the active output fibre are fused such that a stable and one-piece fibre construction results.

In an alternative form, external pump light can also be coupled in in the course of the pump signal combiner by means of a free beam optical unit.

In one embodiment of the laser system, for example, pump light from a pump source is pumped into the lateral surface of the output fibre in the opposite direction to the irradiated laser light via the pump signal combiner, due to which non-absorbed pump light reaches the lateral surface of the mode field adapter.

Non-absorbed pump light can be decoupled from the system in an optionally provided mode stripper on the mode field adapter. This prevents destruction at high pump powers of the fibre components/amplifier fibres, which are arranged in front of the mode field adapter, and undesired coupling of the pump light into the seed source.

The mode stripper section has, in one embodiment, a roughened outer surface on the fibre cladding which can be created, for example, by HF etching of the fibre cladding.

In a further embodiment of the mode stripper, the fibre cladding of the mode stripper section can be covered with a layer which has a higher refraction index than the fibre cladding, due to which non-absorbed pump light is absorbed or laterally decoupled in the cladding.

In one preferred embodiment, the mode stripper section extends over the mode field adaptation section.

In an above-mentioned embodiment of the mode field adapter fibre, in which the expanding core is produced by a TEC method, the cladding has a relatively large cladding diameter of at least 130 μm, in particular a diameter of 400 μm, for example. A homogeneous introduction of heat along the fibre is thus enabled, due to which any tension fields in the core, which result in coupling of power into higher core modes due to tension birefringence, can be reduced/avoided. In addition, non-absorbed pump light from the output/amplifier fibre can be guided largely, preferably completely in the cladding of the mode field adapter. The non-absorbed pump light guided in the cladding can be decoupled in the mode stripper, by which destruction of the fibre due to non-absorbed pump radiation at the mode field adapter is avoided.

Not least, due to the relatively large cladding diameter of the mode field adapter, a high intrinsic strength of the fibre linked thereto is linked, which facilitates the entire production process.

Preferred exemplary embodiments will be described below with the aid of the figures. Elements which are the same or similar, or which have the same effect, are provided with identical reference signs in the various figures, and a repeated description of these elements is sometimes omitted in order to avoid redundancies.

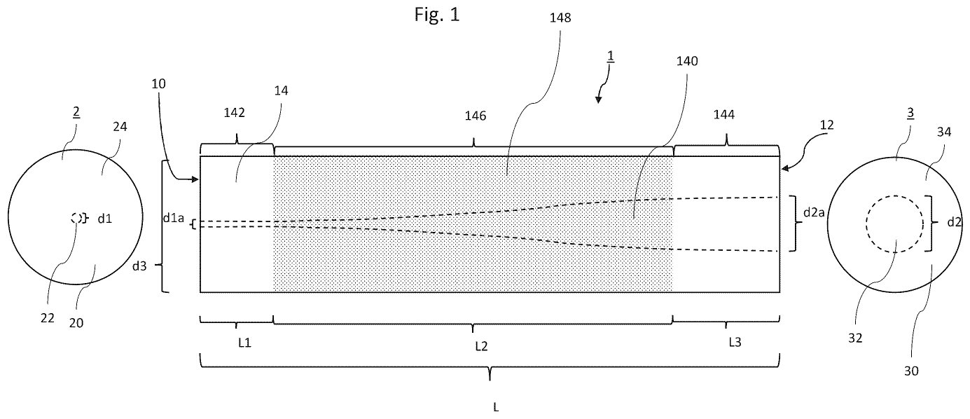

FIG. 1 schematically shows a mode field adapter 1 in a longitudinal section. The mode field adapter 1 has an input side 10 and an output side 12. The input side 10 of the mode field adapter 1 is designed to couple on an input fibre 2, which is shown very schematically in a cross section here. The coupling between the input side 10 of the mode field adapter 1 and the end face 20 of the input fibre 2 can be achieved, for example, via a splicing process.

The output side 12 of the mode field adapter 1 is designed to couple on an output fibre 3, which is also shown very schematically in a cross section here. The coupling between the output side 12 of the mode field adapter 1 and the end face 30 of the output fibre 3 can likewise be achieved via a splicing process, for example.

In FIG. 1, the mode field adapter 1 is shown in a longitudinal section, whereas the input fibre 2 and the output fibre 3 are each shown in a cross section.

As has already been shown, the fibre designs of the input and output fibres can be of different types, which can result in very different properties of the associated mode field of the fibres and in particular does not permit a simple relationship between geometric core diameter and mode field, because some fibre types do not have a well-defined core diameter. For the purposes of a comprehensible description, the mode fields of the outlined fibres in the figures are to be characterized via the mode field diameter. This presumes in particular single mode fibres, since only then is a radially symmetrical profile given by the Gaussian fundamental mode. As already mentioned in the description, however, embodiments of the invention are not restricted to the use of single mode fibres, since a mode field adaptation can also take place via the effective mode field area. Furthermore, the fibres are shown having a single embodiment of the fibre cladding, wherein more complicated designs described at the outset, such as double claddings, are not excluded.

The input fibre 2 has, as can be seen on the schematically shown end face 20, a light-guiding fibre core 22, which is characterized by a first mode field diameter d1. A fibre cladding 24 is formed around the fibre core 22.

The output fibre 3 also has a fibre core 32, which has a second mode field diameter d2. A fibre cladding 34 is also formed around the fibre core 32.

The fibre core 22 of the input fibre 2 has a significantly smaller first mode field diameter d1 than the fibre core 32 of the output fibre 3, which has a second mode field diameter d2.

Since the two mode fields of the fibre core 22 of the input fibre 2 and the fibre core 32 of the output fibre 3 have different diameters, a direct connection of the input fibre 2 to the output fibre 3 is only possible with very high optical losses, since the abrupt transition results in reflections at the interface.

By means of the mode field adapter 1, the mode field of the input fibre 2 can accordingly be equalized or adapted to the mode field of the output fibre 3, by which optical losses in the transition are significantly reduced.

For this purpose, the mode field adapter 1 has a mode field adapter fibre 14, which accordingly has an input side 10 and an output side 12. The mode field adapter fibre 14 has a fibre core 140, which on the input side 10 has a mode field diameter d1a, which corresponds to the mode field diameter d1 of the input fibre 2, and on the output side 12 has a mode field diameter d2a, which corresponds to the mode field diameter d2 of the output fibre 3.

Accordingly, the mode field of the input fibre 2 can be coupled into the mode field adapter 1 and in particular its fibre core 140 by the attachment of the input fibre 2 with its end face 20 on the input side 10 of the mode field adapter 1. At the output side 12 of the mode field adapter 1, the mode field from the fibre core 140 of the mode field adapter 1 can be coupled into the fibre core 32 of the output fibre 3.

The fibre core 140 of the mode field adapter 1 accordingly expands from the input side 10 toward the output side 12. As schematically shown in FIG. 1, in the exemplary embodiment here, the actual adaptation of the mode field diameter of the fibre core 140 of the mode field adapter 1 does not take place over the entire length L of the mode field adapter fibre 14. The length L of the mode field adapter fibre 14 is defined as the length between the input side 10 and the output side 12 of the mode field adapter fibre 14.

Rather, the fibre core 140 of the mode field adapter fibre 14 initially extends from the input side 10 with unchanged first mode field diameter d1a, which corresponds to the mode field diameter d1 of the fibre core 22 of the input fibre 2. This first section 142 of the fibre core 140 of the mode field adapter fibre 14, which is provided with an unchanged mode field diameter, has the length designated as L1 in FIG. 1.

Furthermore, in the exemplary embodiment shown, a further area of the mode field adapter fibre 14 is formed having a fibre core 140 which has a fixed mode field diameter, namely the mode field diameter d2a. This third section 144 having a fixed mode field diameter d2a of the fibre core 140 of the mode field adapter fibre 14 extends from the output side 12 in the direction of the input side 10. This third section 144 has the length designated as L3 in FIG. 1.

Between the two areas, in each of which the fibre core 140 of the mode field adapter fibre 14 of the mode field adapter 1 extends with a fixed mode field diameter, namely in the first section 142 and in the third section 144, a mode field adaptation section 146 is provided, in which the fibre core 140 of the mode field adapter fibre 14 expands, namely from the first mode field diameter d1a of the first section 142 to the second mode field diameter d2a, which is then reached in the third section 144. The mode field adaptation section 146 has a length L2.

The mode field adapter proposed here is not restricted in the three-part structure just described (142, 144, and 146). In particular, the mode field adaptation section 146 can also extend over the entire length L of the mode field adapter 1, due to which no areas having constant mode field diameter would be present.

The mode field adapter fibre 14 of the mode field adapter 1 has a length L between 5 mm and 150 mm, wherein the mode field adaptation section 146 has a length L2 which is between 5 mm and 150 mm and preferably has a length between 15 mm and 50 mm.

In this way, an adaptation of the mode field of the input fibre 2 to the mode field of the output fibre 3 can be achieved and at the same time in this way the mode field adapter 1 can be designed as polarization maintaining. The mode field adapter 1 or in particular the mode field adapter fibre 14 itself may not have any explicitly polarization maintaining structures in this case.

In particular, the mode field adapter fibre 14 does not have any explicitly formed polarization maintaining structures, such as tension rods or other birefringent structures, for example, which are to result in a polarization maintaining propagation of the waves. Asymmetrical fibre or cladding constructions, which could result in maintaining polarization, are also not provided for the mode field adapter fibre.

The input fibre 2 and/or the output fibre 3 can be provided with such polarization maintaining structures, however, as are known, for example, in the area of the so-called PM fibre types, for example by tensioning the different axes in a PM fibre. PM fibre types can also be formed, for example, by the attachment of two glass rods, which are aligned in the longitudinal direction, are doped using boron, and are positioned on opposite sides of the fibre core. Typical embodiments are cylindrical or “bowtie”-shaped glass rods. Elliptical core fibres can also be used or other asymmetrical designs of the fibre or the fibre core, which can accordingly have a polarization maintaining effect for the input fibre 2 and/or the output fibre 3. Such asymmetrical designs can also be implemented for the fibre cladding, and also result in a polarization maintaining fibre. For the case of photonic crystal fibres, in particular asymmetrical arrangements of the microstructured hole structure can be used, in order to achieve a polarization maintaining effect.

Such polarization maintaining structures are explicitly not provided in the mode field adapter fibre 14. Rather, only a mode field adapter fibre 14 is provided here, which has, for example, a thermally expanded core.

The cladding diameter d3 of the mode field adapter fibre 14 is preferably constant continuously over the entire area of the mode field adapter fibre 14, thus over its entire length L. In other words, the diameter and in particular the cladding diameter d3 of the mode field adapter fibre 14 does not change. It is only the fibre core 140 which has a corresponding enlargement from the mode field diameter d1a to the mode field diameter d2a in the mode field adaptation section 146.

The cladding diameter d3 of the mode field adapter fibre 14 can be, for example, larger than 130 μm-preferably smaller than 900 μm. In this way, the heat during the production process can be introduced homogeneously and tension fields in the fibre core 140 can be reduced or avoided.

Furthermore, with a constant cladding diameter d3 of the mode field adapter fibre 14, non-absorbed pump light from the amplifier can be guided in the cladding and decoupled by an optional mode stripper (described below) at the lateral surface, by which destruction due to non-absorbed radiation can be avoided at the mode field adapter fibre 14.

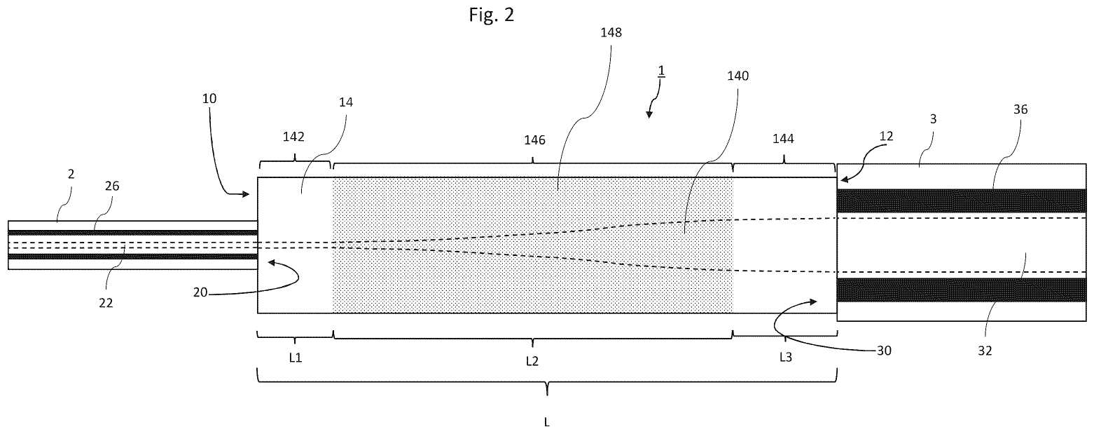

FIG. 2 shows the mode field adapter 1 in a state connected to the input fibre 2 and the output fibre 3, wherein the end face 20 of the input fibre 2 has accordingly been connected by means of a splicing process to the input side 10 of the mode field adapter fibre 14, such that the fibre core 22 of the input fibre 2 is aligned with the fibre core 140 of the mode field adapter fibre 14, so that accordingly coupling of the modes from the input fibre 2 into the mode field adapter fibre 14 is enabled.

Similarly, the output fibre 3 is spliced with its end face 30 on the output side 12 of the mode field adapter fibre 14 so that the modes propagating in the mode field adapter fibre 14 and in particular in its fibre core 140 are coupled directly into the fibre core 32 of the output fibre 3. In the case of the single mode fibres predominantly discussed here, preferably only the fundamental mode is to be coupled in here in order to ensure a high beam quality. However, this does not preclude the use of the mode field adapter 1 together with multimode fibres having multimode light wave propagation.

The connection of the input fibre 2 to the mode field adapter fibre 14 or the connection of the output fibre 3 to the mode field adapter fibre 14 can be achieved via a known splicing process or via a cleaving and splicing process so that the lowest loss possible coupling from the input fibre 2 into the mode field adapter 1 and the lowest loss possible decoupling from the mode field adapter 1 to the output fibre 3 is enabled.

For the special case of input-side and output-side single mode fibres, it is preferred for the input fibre 2 having fibre core 22, which can guide a fundamental mode using a mode field diameter d1, to be adapted using the mode field adapter fibre 14 on the input side having a core 140, which can guide a fundamental mode using mode field diameter d1a in the area 142, so that (for example by means of a splice of input fibre 2 to the end face 10 of the mode field adapter fibre 14) optical coupling of the mode field diameters d1 and d1a is possible with a loss of <3 dB, preferably <1 dB. On the output side, the mode field adapter fibre 14 is to have a fibre core 140 having a fundamental mode having mode field diameter d2a, so that an optical coupling of d2a and the mode field diameter d2 of the fundamental mode of the core 32 of the output fibre 3 is possible with a loss of <3 dB, preferably <2 dB.

The input fibre 2 has polarization maintaining structures 26, which are shown very schematically here and are provided, for example, in the form of two glass rods extending in the longitudinal direction of the input fibre 2 and doped using boron.

The output fibre 3 also has schematically shown polarization maintaining structures, which can be provided, for example, in the form likewise of glass rods 36 extending in the longitudinal direction of the output fibre 3 and doped using boron.

The mode field adapter fibre 14 can furthermore have at least one mode stripper section 148, which is designed so that pump light can be decoupled from the cladding. The mode stripper section 148 is accordingly designed so that pump light can be decoupled and non-absorbed pump light, which could possibly result in destruction of the mode field adapter fibre 14 or other components, can be decoupled.

The mode stripper section 148 can be formed, for example, as a layer having a higher refraction index than the cladding layer or can be a roughened lateral surface in order to correspondingly achieve the property of a mode stripper.

In one preferred embodiment, the mode stripper section 148 extends along the mode field adaptation section 146, so that non-absorbed pump light can be decoupled accordingly.

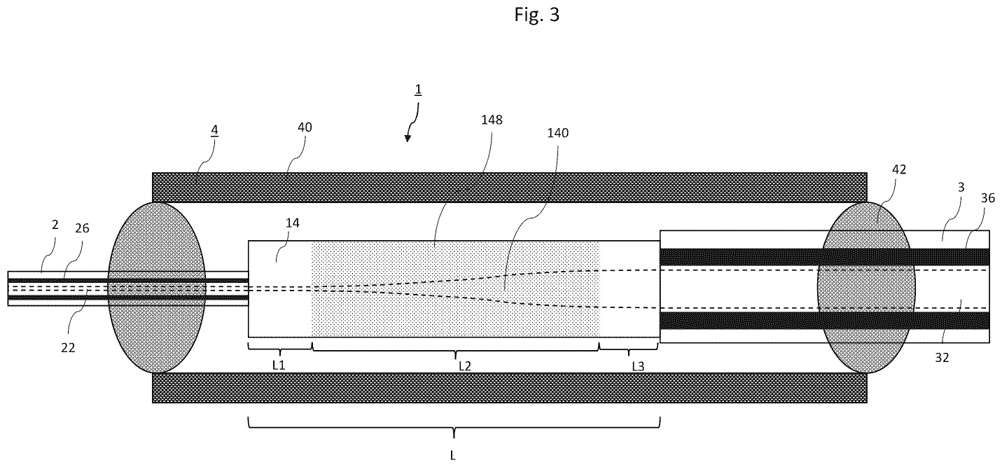

FIG. 3 schematically shows the mode field adapter 1, which comprises the mode field adapter fibre 14, on which both the input fibre 2 and the output fibre 3 are spliced—for example, in the form described in FIGS. 1 and 2.

The mode field adapter fibre 14 is held in a mount 4, which can be designed, for example, in the form of a tube 40. Both the mode field adapter fibre 14 and the respective ends of the input fibre 2 and the output fibre 3 are held in the tube 40. This can be achieved, for example, via corresponding adhesive drops 42, using which the end of the input fibre 2 and the beginning of the output fibre 3 are adhesively bonded to the tube 40 of the mount 4. The adhesive bonding can take place, for example, on a polymer coating, which is typically arranged around the glass fibres. The mode field adapter fibre 14 is not directly adhesively bonded to the tube 40 in the exemplary embodiment shown.

The mount 4 for holding the mode field adapter fibre 14 is designed so that the mode field adapter fibre 14 is held unbent in the mount 4. In particular, it is held straight and preferably with a radius of curvature of greater than 10 m. The mode field adapter fibre 14 is preferably mounted without tension in the mount 4.

In this way, it is possible for the mode field adapter fibre 14 to nonetheless maintain the polarization even without the explicit provision of polarization maintaining structures.

The tube 40 can be a glass tube, for example. In particular, the tube can experience the same thermal expansion as the mode field adapter fibre itself in the case of a TEC process, which is used for the expansion of the core of the mode field adapter fibre.

The change of the polarization state, thus the percentage proportion of the irradiated polarization of light which is converted during the passage through the mode field adapter fibre into the polarization orthogonal thereto, is less than 25% (−6 dB), preferably less than 1% (−20 dB).

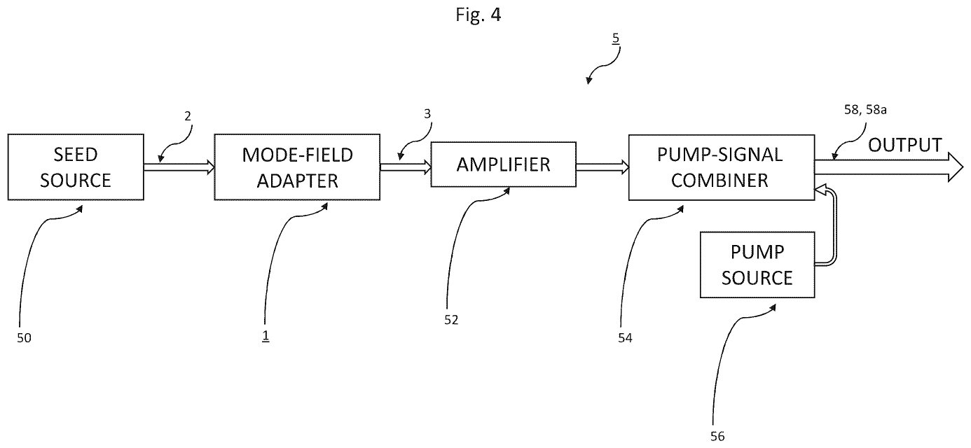

FIG. 4 schematically shows a laser system 5, in which the mode field adapter 1 is used. A seed source 50 is provided here, which is designed, for example, in the form of a diode having a fibre amplifier, a fibre oscillator, and possibly a preamplifier. Laser radiation is generated, for example, in the form of pulsed laser radiation by the seed source 50. A fibre having a small mode field diameter is used here, for example, in the seed source 50.

The laser pulses generated by the seed source 50 are then to be amplified in an optical amplifier 52, wherein the amplifier 52 is designed in the form of a doped amplifier fibre having a larger mode field diameter than the mode field diameter of the seed source 50. Accordingly, laser pulses are provided from the seed source 50 via an input fibre 2, which has a first mode field diameter d1 of the fibre core 22, and adapted by means of the above-described mode field adapter 1 to a larger mode field diameter d2 of an output fibre 3 and then fed to the optical amplifier 52.

The amplifier 52 is pumped from the end by means of a pump signal combiner 54. Furthermore, a pump source 56 is provided for this purpose. Non-absorbed pump light can be decoupled here in a mode stripper section of the mode field adapter 1.

The laser radiation amplified via the amplifier 52 or the laser pulses of the seed source 50, which are amplified via the amplifier 52, can be decoupled as a free beam 58. Alternatively, the decoupling of the laser radiation can also be embodied by means of an output fibre 58a.

The polarization of the laser pulses of the seed source 50 is obtained by the correspondingly designed mode field adapter 1 and can then be maintained in the amplifier 52, so that the polarization is still correspondingly maintained at the output fibre 58.

Insofar as applicable, all individual features presented in the exemplary embodiments may be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 mode field adapter
10 input side
12 output side
14 mode field adapter fibre
140 fibre core
142 first section
144 third section
148 mode stripper section
2 input fibre
20 end face
22 fibre core
24 fibre cladding
26 polarization maintaining structure
3 output fibre
30 end face
32 fibre core
34 fibre cladding
36 polarization maintaining structure
4 mount
40 tube
42 adhesive/sealing compound
5 laser system
50 seed source
52 optical amplifier
54 pump/signal combiner
56 pump source
58 output fibre
d1 first mode field diameter
d2 second mode field diameter
d1a first mode field diameter of the mode field adapter fibre
d2a second mode field diameter of the mode field adapter fibre
d3 cladding diameter
L length of the mode field adapter fibre
L1 length of the first section 142
L2 length of the mode field adaptation section 146
L3 length of the third section 144

1. A mode field adapter for adapting a mode field of an input fibre to a mode field of an output fibre, the mode field adapter comprising a mode field adapter fibre,
the mode field adapter fibre comprising a mode field adaptation section for adapting a mode field diameter of the mode field of the input fibre to the mode field of the output fibre, wherein the mode field adapter fibre has a length between 5 mm and 150 mm, and the mode field adaptation section has a length between 5 mm and 150 mm, wherein the mode field adapter fibre is configured to transfer light from the input fibre in a polarization maintaining manner into the output fibre.

2. The mode field adapter according to claim 1, wherein the mode field adapter fibre does not have tension rods, or birefringent structures, or asymmetrical fibre or cladding constructions.

3. The mode field adapter according to claim 1, further comprising a mount for mounting the mode field adapter fibre, wherein the mode field adapter fibre is mounted without tension in the mount.

4. The mode field adapter according to claim 1, further comprising a mount for mounting the mode field adapter fibre, wherein the mode field adapter fibre is mounted unbent.

5. The mode field adapter according to claim 1, further comprising a mount for mounting the mode field adapter fibre, wherein the mode field adapter fibre is mounted so that a radius of curvature is greater than 10 m.

6. The mode field adapter according to claim 3, wherein the mount comprises a tube.

7. The mode field adapter according to claim 6, wherein each of the input fibre and the output fibre is mounted by using an adhesive spot in the tube, so that the mode field adapter fibre is indirectly mounted in the tube, wherein the two adhesive spots close the tube.

8. The mode field adapter according to claim 1, wherein a change of polarization state of the light during passage through the mode field adapter fibre is less than 25%.

9. The mode field adapter according to claim 1, wherein the mode field adapter fibre is polished and/or cleaved on an input side, and the input fibre is spliced on the input side.

10. The mode field adapter according to claim 1, wherein the mode field adapter fibre is polished and/or cleaved on an output side, and the output fibre is spliced on the output side.

11. The mode field adapter according to claim 1, wherein the mode field adapter fibre has a fibre core, wherein a mode field diameter of the fibre core in the mode field adaptation section on an input side corresponds to a mode field diameter of a fibre core of the input fibre, and a mode field diameter of the fibre core in the mode field adaptation section on an output side corresponds to a mode field diameter of a fibre core of the output fibre.

12. The mode field adapter according to claim 11, wherein the fibre core of the mode field adapter fibre is a thermally expanded core.

13. The mode field adapter according to claim 1, wherein the mode field adapter fibre has a fibre cladding, wherein a diameter of the fibre cladding is constant over the length of the mode field adapter fibre, wherein the diameter of the fibre cladding is greater than 130 μm.

14. The mode field adapter according to claim 13, wherein the mode field adapter fibre has at least one mode stripper section configured to decouple pump light from the mode field adapter fibre cladding.

15. The mode field adapter according to claim 14, wherein the mode stripper section is implemented by a layer on the mode field adapter fibre cladding, which has a greater refraction index than the mode field adapter fibre cladding, and/or the mode stripper section is implemented by a roughened mode field adapter fibre cladding surface.

16. A laser system comprising a seed laser, a mode field adapter according to claim 1, an amplifier having an amplifier fibre, a pump signal combiner, and a pump laser,
wherein the seed laser is configured to generate laser radiation having a mode field in the input fibre, wherein the mode field adapter is configured to adapt the mode field of the input fibre to the mode field of the output fibre, wherein the output fibre is an amplifier fibre of the amplifier, wherein the amplifier is configured to amplify the laser radiation, wherein the pump combiner is configured to pump the amplifier using the laser radiation of the pump laser, wherein the laser system is polarization maintaining.
